(19) United States
(12) Patent Application Publication
(10) Pub. No.: US 2013/0166644 A1
(43) Pub. Date: Jun. 27, 2013

(54) System and Method for Resource Management in Multiple Communications Point Operation

(71) Applicants: Yishen Sun, Buffalo Grove, IL (US); Hao Bi, Lake Zurich, IL (US)

(72) Inventors: Yishen Sun, Buffalo Grove, IL (US); Hao Bi, Lake Zurich, IL (US)

(73) Assignee: FutureWei Technologies, Inc., Plano, TX (US)

(21) Appl. No.: 13/336,794

(22) Filed: Dec. 23, 2011

(51) Int. Cl. G06F 15/16

(52) U.S. Cl. 709/204

(57) ABSTRACT

A method for operating a communications point includes receiving a first message from a candidate communications point in a communications points set associated with a user equipment (UE), where the first message includes a resource report advising of an available portion of an upper layer communications resource that can be committed by the candidate communications point in a collaboration with a first communications point to communicate with the UE. The method also includes sending a second message to the candidate communications point, the second message including a resource reservation request to reserve a subset of the available portion of the upper layer communications resource. The method further includes receiving a third message from the candidate communications point, the third message including a resource reservation response indicating whether the subset of the available portion of the upper layer communications resource has been reserved as requested.

### TECHNICAL FIELD

The present invention relates generally to digital communications, and more particularly to a system and method for resource management in multiple communications point operation.

### BACKGROUND

In order to achieve better channel utilization and increase overall performance, multiple transmission and multiple reception antennas (also commonly referred to as multiple input, multiple output (MIMO)) at both evolved Node B (eNB) (or base station (BS), Node B (NB), communications controller, and the like) and User Equipment (UE) (or mobile station (MS), terminal, user, subscriber, subscriber equipment, and the like) are considered.

An extension to MIMO makes use of multiple communications points (each of which may be a set of geographically co-located transmit or receive antennas) to transmit or receive to or from a single UE or a group of UEs. As an example, the transmissions from the multiple transmission points may occur at the same time and/or the same frequency, or they may occur at different times and/or at different frequencies so that the UE (or the group of UEs) will receive transmissions from all of the multiple transmission points over a time window. This operating mode may often be referred to as multiple point transmission. As an example, at a first time, a first transmission point may transmit to a UE, at a second time, a second transmission point may transmit to the UE, and so on. Here the second time may or may not be the same as the first time.

Coordinated multiple point (CoMP) transmission is one form of multiple point transmission, wherein the transmissions made by the multiple transmission points are coordinated so that the UE or the group of UEs may be able to either combine the transmissions made by the multiple transmission points or avoid interference to improve overall performance. A transmission point may be an eNB, a part of an eNB (i.e., a cell), a remote radio head (RRH) connected to an eNB, or so on. It is noted that sectors of the same site, e.g., an eNB, correspond to different transmission points. Similarly, CoMP reception involves the reception of a transmitted signal(s) at multiple geographically separated reception points.

CoMP transmission and reception is being considered for inclusion in next generation wireless communications systems, such as in Third Generation Partnership Project (3GPP) Long Term Evolution (LTE) Advanced standards compliant communications systems, as a tool to improve the coverage of high data rates, cell-edge throughput, and/or to increase overall communications system throughput in both high load and low load scenarios.

### SUMMARY OF THE INVENTION

Example embodiments of the present invention which provide a system and method for resource management in multiple communications point operation.

In accordance with an example embodiment of the present invention, a method for operating a network entity is provided. The method includes receiving a first message from a candidate communications point in a communications points set associated with a user equipment (UE), where the first message includes a resource report advising of an available portion of an upper layer communications resource that can be committed by the candidate communications point in a collaboration with a first communications point to communicate with the UE. The method also includes sending a second message to the candidate communications point, the second message including a resource reservation request to reserve a subset of the available portion of the upper layer communications resource, and receiving a third message from the candidate communications point, the third message including a resource reservation response indicating whether the subset of the available portion of the upper layer communications resource has been reserved as requested.

In accordance with another example embodiment of the present invention, a method for operating a network entity is provided. The method includes receiving a first message from a first communications point, the first message including a resource reconfiguration request indicating a change in a portion of an upper layer communications resource committed by the first communications point. The method also includes determining if a second communications point accepts a commitment of a second portion of the upper layer communications resource, the second portion of the upper layer communications resource according to the change in the portion of the upper layer communications resource. The method further includes sending a second message to the first communications point, the second message including a resource reconfiguration response indicating whether the second communications point accepted the commitment of the second portion of the upper layer resource.

In accordance with another example embodiment of the present invention, a communications point is provided. The communications point includes a receiver, and a transmitter. The receiver receives a first message from a candidate communications point in a communications points set associated with a user equipment (UE), where the first message includes a resource report that advises of an available portion of an upper layer communications resource that can be committed by the candidate communications point in a collaboration with a first communications point to communicate with the UE, and receives a third message from the candidate communications point, the third message including a resource reservation response indicating whether a subset of the available portion of the upper layer communications resource has been reserved as requested. The transmitter sends a second message to the candidate communications point, the second message including a resource reservation request to reserve the subset of the available portion of the upper layer communications resource.

In accordance with another example embodiment of the present invention, a communications point is provided. The communications point includes a receiver, a processor coupled to the receiver, and a transmitter. The receiver receives a first message from a first communications point, the first message including a resource reconfiguration request indicating a change in a portion of an upper layer communications resource committed by the first communications point. The processor determines if a second communications point accepts a commitment of a second portion of the upper layer communications resource, the second portion of the upper layer communications resource according to the change in the portion of the upper layer communications resource. The transmitter sends a second message to the first communications point, the second message including a resource reconfiguration response indicating whether the second communications point accepted the commitment of the second portion of the upper layer resource.

One advantage of an embodiment is that the use of higher layer information helps to make resource provisioning more reliable and consistent than simply using basic low layer information, such as channel quality information. Furthermore, the resource provisioning more accurately reflects the available resources.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example communications system according to example embodiments described herein;

FIG. 2 illustrates an example communications system, wherein a transport of packets is highlighted according to example embodiments described herein;

FIG. 3 illustrates an example portion of a protocol stack used in data transmission over a radio bearer according to example embodiments described herein;

FIG. 4 illustrates an example communications system, wherein DL CoMP transmission is taking place for some of the UEs operating in a coverage area of communications system according to example embodiments described herein;

FIG. 5 illustrates an example communications system, wherein the communications system comprises a variety of transmission points according to example embodiments described herein;

FIG. 6 illustrates an example relationship diagram for multiple point operating sets according to example embodiments described herein;

FIGS. 7a through 7c illustrate example message exchanges in confirmation of commitment of upper layer resources in selecting, coordinating, and/or maintaining a multiple point operating set according to example embodiments described herein;

FIG. 8 illustrates an example flow diagram of operations in a Point A as the Point A participates in confirmation of commitment of upper layer resources in selecting, coordinating, and/or maintaining a multiple point operating set according to example embodiments described herein;

FIG. 9 illustrates an example flow diagram of operations in a candidate transmission point as the candidate transmission point participates in confirmation of commitment of upper layer resources in selecting, coordinating, and/or maintaining a multiple point operating set according to example embodiments described herein;

FIGS. 10a through 10d illustrate example message exchanges in confirmation of commitment of upper layer resources in selecting, coordinating, and/or maintaining a multiple point operating set with a Point B initiating the selecting, coordinating, and/or maintaining of a multiple point operating set according to example embodiments described herein;

FIG. 11 illustrates an example flow diagram of operations in a primary transmission point as the primary transmission point participates in a Point B initiated confirmation of commitment of upper layer resources in selecting, coordinating, and/or maintaining a multiple point operating set according to example embodiments described herein;

FIG. 12 illustrates an example message according to example embodiments described herein;

FIG. 13 illustrates an example first communications device according to example embodiments described herein; and

FIG. 14 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present invention provides many applicable inventive concepts that can be embodied in a wide variety of specific contexts. The specific embodiments discussed are merely illustrative of specific structures of the invention and ways to operate the invention, and do not limit the scope of the invention.

One embodiment of the invention relates to resource management in a communications system using upper layer information. For example, an entity responsible for resource management, such as a primary transmission point, a secondary transmission point, a controller, or a management entity, may receive upper layer information in addition to low layer information (e.g., physical layer information) from candidate transmission points. The entity makes use of the upper layer information, for example, changes in allocations thereof, and the low layer information to manage candidate transmission point(s) and multiple point operating sets. The management of candidate transmission point(s) and multiple point operating sets may be initiated by the entity or by a current member of a multiple point operating set.

The present invention will be described with respect to example embodiments in a specific context, namely a 3GPP LTE-Advanced compliant communications system. The invention may also be applied, however, to other standards compliant communications systems, such as IEEE 802.16m, WiMAX, and so on, as well as non-standards compliant communications systems that support multiple point communication.

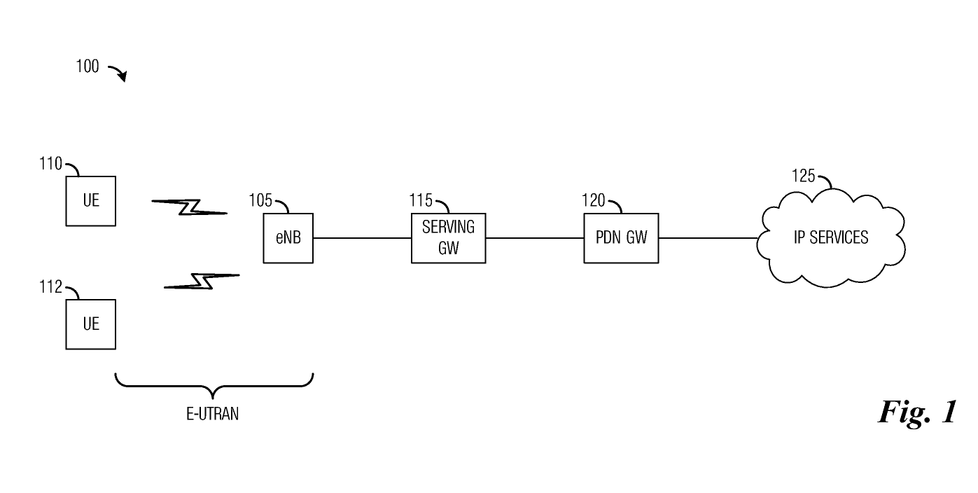

FIG. 1 illustrates a communications system 100. Communications system 100 includes an eNB 105 serving UE 110 and UE 112. eNB 105 (as well as other eNBs and their associated cells) provides an air interface for communications system 100 and is commonly referred to as an Enhanced Universal Mobile Telecommunications System (UMTS) Terrestrial Radio Access Network (E-UTRAN). A connection may be setup from a UE through eNB 105, a serving gateway (serving GW) 115, and a packet data network gateway (PDN GW) 120 to an operator's Internet Protocol (IP) services network 125.

While it is understood that communications systems may employ multiple eNBs capable of communicating with a number of UEs, only one eNB, two UEs, one serving GW, and one PDN GW are illustrated for simplicity.

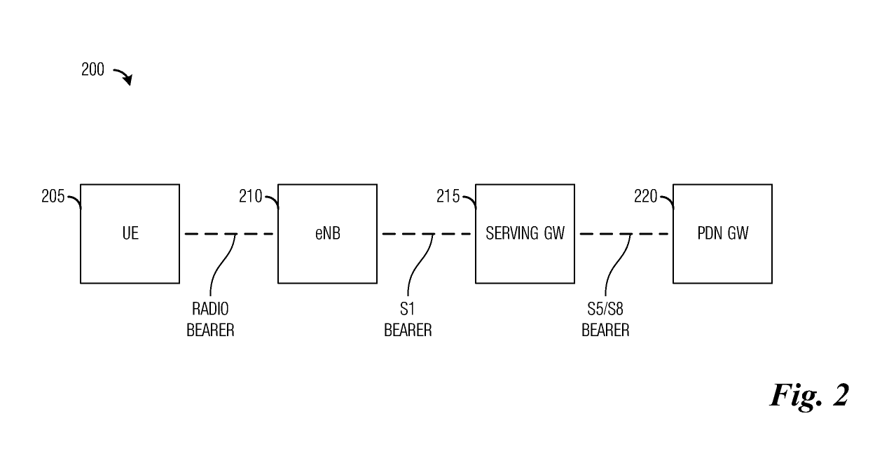

FIG. 2 illustrates a communications system 200, wherein a transport of packets is highlighted. The transport of packets from PDN GW 220 to UE 205 may be organized through Evolved Packet System (EPS) bearers, which may consist of radio or wireline bearers. Between PDN GW 220 and serving GW 215, an S5/S8 bearer supports the transport of packets, while between serving GW 215 and eNB 210, an S1 bearer supports the transport of packets. A radio bearer supports the transport of packets between eNB 210 and UE 205. Traffic flows may be aggregated and then sent over respective bearers to their intended destination.

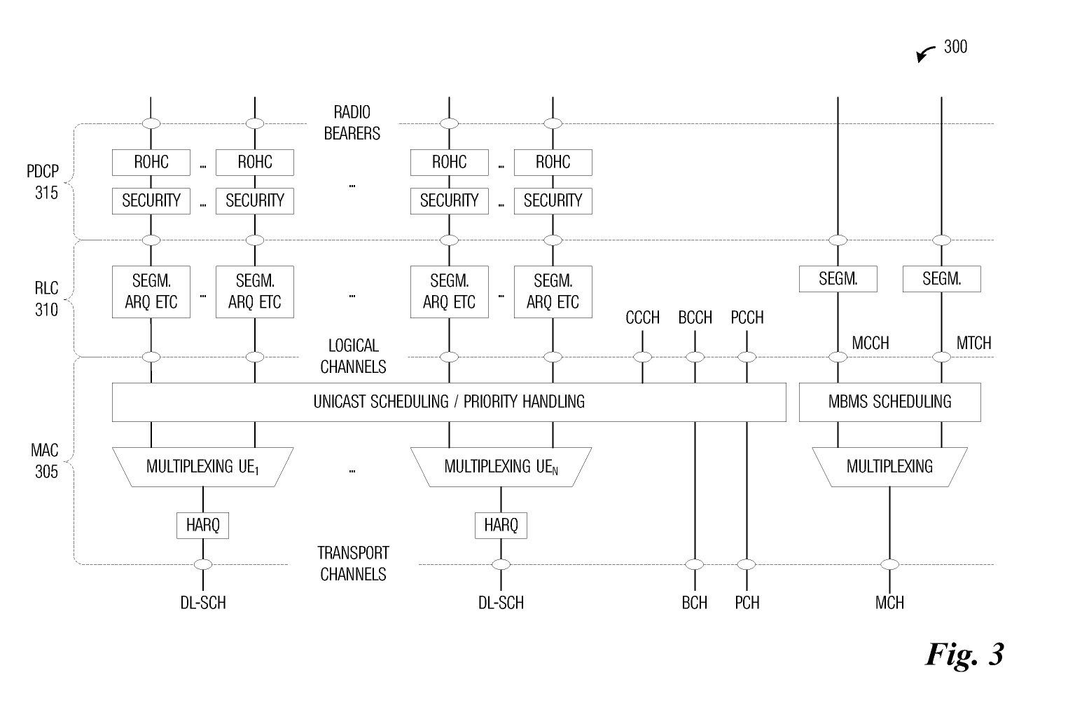

FIG. 3 illustrates a portion of a protocol stack 300 used in data transmission over a radio bearer. Protocol stack 300 illustrates a medium access control (MAC) layer 305, a radio link control (RLC) layer 310, and a packet data convergence control (PDCP) layer 315. In current generation 3GPP LTE communications systems (e.g., 3GPP LTE Release-8, Release-9, and Release-10), each radio bearer of a UE is associated with one PDCP entity, and each PDCP entity is associated with one RLC entity for downlink (DL) transmissions.

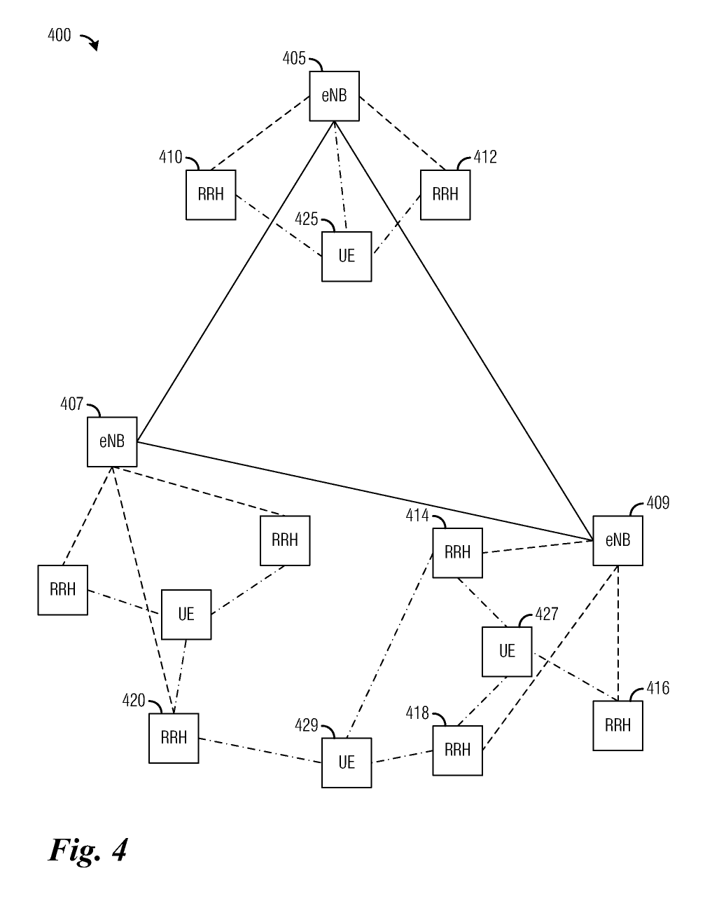

FIG. 4 illustrates a communications system 400, wherein DL multiple point transmission (e.g., CoMP transmission) is taking place for some of the UEs operating in a coverage area of communications system 400.

Although the discussion of FIG. 4 focuses on eNBs as communications controllers, other types of communications controllers may be used in place of or in conjunction with eNBs. For example, BSs, Low Power Nodes (LPN), femto cells, pico cells, and so on, may be used as replacements of or in conjunction with eNBs. Therefore, the discussion of eNBs should not be construed as being limiting to either the scope or the spirit of the example embodiments.

Furthermore, the discussion presented herein focuses on CoMP transmission. However, the example embodiments presented here are also operable with a more general form of CoMP transmission, i.e., multiple point transmission. Therefore, the discussion of CoMP transmission should not be construed as being limiting to either the scope or the spirit of the example embodiments.

Communications system 400 includes a number of eNBs, such as eNB 405, eNB 407, and eNB 409, and a number of remote radio heads (RRH), such as RRH 410, RRH 412, RRH 414, RRH 416, RRH 418, and RRH 420. Communications system 400 also includes a number of UEs, such as UE 425, UE 427, and UE 429. The UEs may be served by one or more eNBs, one or more RRHs, or a combination of eNBs and RRHs. The eNBs may allocate a portion of their bandwidth to the RRHs in order to help improve coverage, performance, and so forth.

As shown in FIG. 4, UE 425 may be served by RRH 410 and RRH 412, as well as eNB 405, while UE 427 may be served by RRH 414, RRH 416, and RRH 418. UE 429 may be served by RRHs controlled by different eNBs, such as RRH 414 and RRH 418 (controlled by eNB 409) and RRH 420 (controlled by eNB 407).

A transmission point within a set may be referred to as a primary transmission point (or simply primary or primary point) and the remaining transmission point(s) in the set may be referred to as secondary transmission point(s) (or simply secondary, secondary point, secondaries, or secondary points). The primary transmission point may be considered to be a controlling transmission point for a UE, responsible for exchanging control signal messages (e.g., radio resource control messages) with the UE.

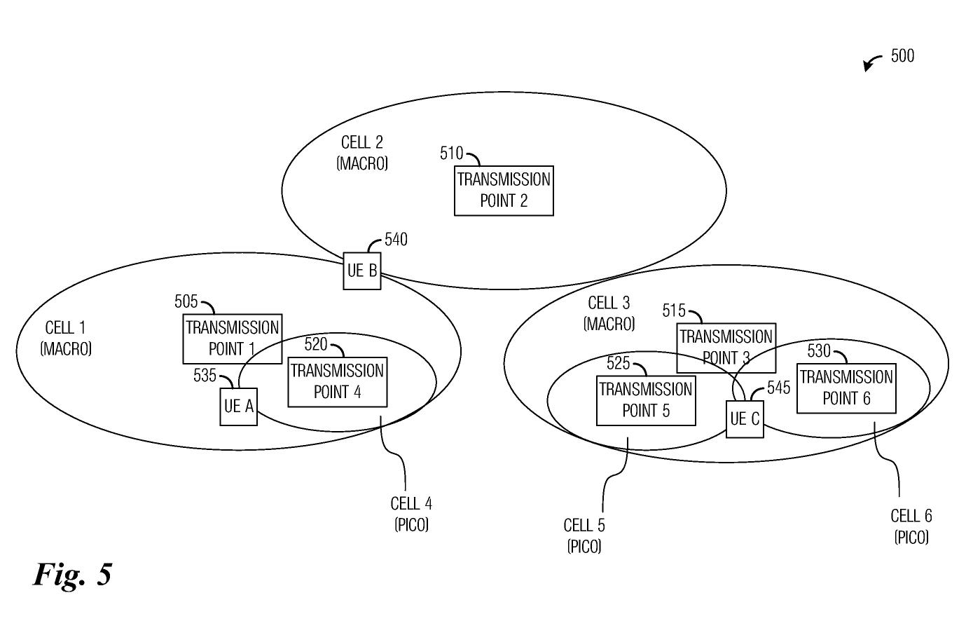

FIG. 5 illustrates a communications system 500, wherein communications system 500 comprises a variety of transmission points. Communications system 500 includes a plurality of macro cell transmission points, such as transmission point 1 505, transmission point 2 510, and transmission point 3 515. In general, macro cell transmission points are full power transmission points and are part of a planned infrastructure. Communications system 500 also includes a plurality of pico cell transmission points, such as transmission point 4 520, transmission point 5 525, and transmission point 6 530. Typically, pico cell transmission points are reduced power transmission points that are deployed to help improve coverage in low coverage areas or to provide additional resources in high usage areas. Pico cell transmission points may or may not be part of a planned infrastructure. Examples of pico cell transmission points include femto cell transmission points, home evolved NodeBs (HeNB), and the like.

Communications system 500 also includes a plurality of UEs, such as UE A 535, UE B 540, and UE C 545. As shown in FIG. 5, UE A 535 may be located so that it is capable of receiving transmissions from transmission point 1 505 and/or transmission point 4 520 as well as making transmissions to transmission point 1 505 and/or transmission point 4 520. Similarly, UE B 540 is capable of communicating with transmission point 1 505 and transmission point 2 510, and UE C 545 is capable of communicating with transmission point 3 515, transmission point 5 525, and transmission point 6 530.

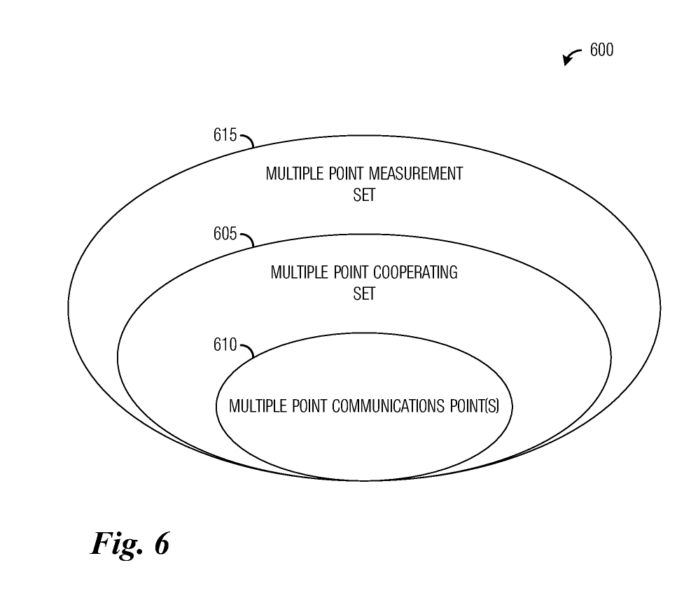

FIG. 6 illustrates a relationship diagram 600 for multiple point operating sets. Multiple point operating sets comprise three sets: a multiple point cooperating set 605, a multiple point communications point set 610, and a multiple point measurement set 615. Multiple point cooperating set 605 includes a set of communications (transmission or reception) points, which may or may not be geographically separated, directly or indirectly participating in communicating data information to a UE in a time-frequency resource. Multiple point communications point set 610 includes a set of communications (transmission or reception) points, which may or may not be geographically separated, communicating data with a UE. Multiple point communications (transmission or reception) point set 610 is a subset of multiple point cooperating set 605.

Multiple point measurement set 615 includes a set of communications (transmission or reception) points that channel information, such as channel state information, channel statistical information, and the like, about which a wireless communications link between a respective communications (transmission or reception) point in the set and a UE is reported. Multiple point measurement set 615 is a superset of multiple point cooperating set 605.

It is noted that multiple point cooperating set 605, multiple point communications point set 610, and multiple point measurement set 615 may be defined for UL communications, DL communications, or both. It is also noted that an UL multiple point operating set may be different from its corresponding DL multiple point operating set. As an example, an UL multiple point cooperating set may be different from a DL multiple point cooperating set.

As discussed previously, CoMP is a specific form of multiple point operation wherein multiple communications (transmission or reception) points transmits or receives in a coordinated way. Therefore, the discussion of multiple point operation also applies to CoMP operation and should not be construed as being limiting to either the scope or the spirit of the example embodiments.

Typically, a discussion of a communications point (or features and/or characteristics thereof) also applies to a transmission point or a reception point. Therefore, the discussion of communications points, sets of communications points, and vice versa, should not be construed as being limiting to the scope or the spirit of the example embodiments. Similarly, a discussion of a transmission point (or features and/or characteristics thereof) also applies to a reception point and a communications point. Therefore, the discussion of transmission points, sets of transmission points, and the like, should not be construed as being limiting to the scope or spirit of the example embodiments.

Generally, a network side of a communications system (such as an eNB, a multiple point controller, a mobility management entity (MME), and the like) is responsible for selecting, coordinating, and/or maintaining multiple point operating sets. The network side is also responsible for coordinating the resource usage among the different transmission points in the multiple point operating sets. In order to simplify discussion, it is assumed that the selecting, coordinating, and/or maintaining of the multiple point operating sets are for DL multiple point operating sets. However, the example embodiments are also applicable to UL multiple point operating sets. Therefore, the discussion of DL multiple point operating sets should not be construed as being limiting to either the scope or the spirit of the example embodiments.

Typically, an entity (such as a primary transmission point, a secondary transmission point, a multiple point controller, and the like) responsible for selecting, coordinating, and/or maintaining multiple point operating sets obtains information about the channel condition of communications links between the UE and different communications points. The information about the channel condition of the communications links (also commonly referred to a low layer information) is usually used to provision for physical layer transmission and/or reception quality.

However, low layer information regarding physical layer transmission and/or reception quality does not necessarily ensure better upper layer (e.g., radio link control (RLC) layer, packet data convergence protocol (PDCP) layer, radio resource control (RRC) layer, and the like) performance. As an example, referencing FIG. 5 and considering a situation where an entity is selecting a DL multiple point cooperating set for UE C 545, the entity may consider both transmission point 5 525 and transmission point 6 530. It is possible that the channel condition of a communications link between transmission point 5 525 and UE C 545 is better than that of the communications link between transmission point 6 530 and UE C 545. However, if the number of active UE being served by transmission point 5 525 is significantly higher than the number of active UE being served by transmission point 6 530, then non-multiple point communications traffic load of transmission point 5 525 might be much heavier than the non-multiple point communications traffic load of transmission point 6 530. Consequently, transmission point 5 525 may not be able to handle the multiple point communications load traffic with transmission point 3 515 jointly in a timely manner. Hence, channel condition alone may not be sufficient to provide good results when selecting, coordinating, and/or maintaining multiple point operating sets.

According to an example embodiment, in addition to the low layer information, upper layer information is used by the entity when selecting, coordinating, and/or maintaining multiple point operating sets. Upper layer information provided by transmission points and used by the entity may include, but are not limited to, the basic elements:
Subframe availability: Specify information about subframes during which multiple point transmission and/or reception is allowed. Subframe availability is usable by the entity to evaluate potential latency that may be incurred. The subframe availability may be reported as an indication, such as an index number, a bitmap, a plurality of bitmaps, a set of subframes, a set of indices, and the like. It is noted that it is possible that not all subframes will be available for multiple point operation due to restrictions and/or configurations such as almost blank subframe (ABS), backhaul link/access link (Un/Uu) subframes, multimedia broadcast-multicast service (MBMS) subframes, as well as those subframes that are reserved for other uses, such as a candidate transmission point's own UE's traffic and routine operations;
Bandwidth: Specify information about bandwidth that can be committed for allocation for multiple point transmission and/or reception. The bandwidth may be specified in terms of a maximum value, a minimum value, or an average value over a specified time window;
Quality of Service (QoS) level: Specify information about a QoS requirement that a multiple point traffic should meet so that the transmission and/or reception of the multiple point traffic can be committed by a communications point. A communications point may be willing to use its resources for multiple point operation only to multiple point traffic of importance, e.g., the QoS level and/or priority of the traffic exceeding a specified threshold; and
Multiple point communications scheme category: Specify multiple point communications scheme categories supported by a communications point. As an example, for CoMP operation, a transmission point may specify different CoMP categories (such as joint processing, dynamic point selection, joint transmission, coordinated scheduling and/or coordinated beamforming (coordinated scheduling/coordinated beamforming), and the like). Multiple point communications scheme categories may be reported as an indication, such as scheme index, a bitmap, a plurality of bitmaps, a set of scheme indices, and the like.
Multiple point communications data splitting level option: Specify multiple point communications data splitting level options supported by a communications point. As an example, CoMP data splitting level (such as MAC level, RLC level, PDCP level, and the like) may be specified by the transmission point. Multiple point communications data splitting level options may be reported as an indication, such as level index, a bitmap, a plurality of bitmaps, a set of level indices, and the like.

Additionally, the upper layer information may include some variations of its basic components, such as:
The upper layer information is a blend of several (e.g., two or more) of the above listed forms of upper layer information. As an example, it is possible to blend subframe availability and bandwidth together by reporting bandwidth per subframe for a number of subframes; and
The upper layer information is specified differently for different multiple point scheme categories. As an example, subframe availability may be different for dynamic point selection as compared to joint transmission.

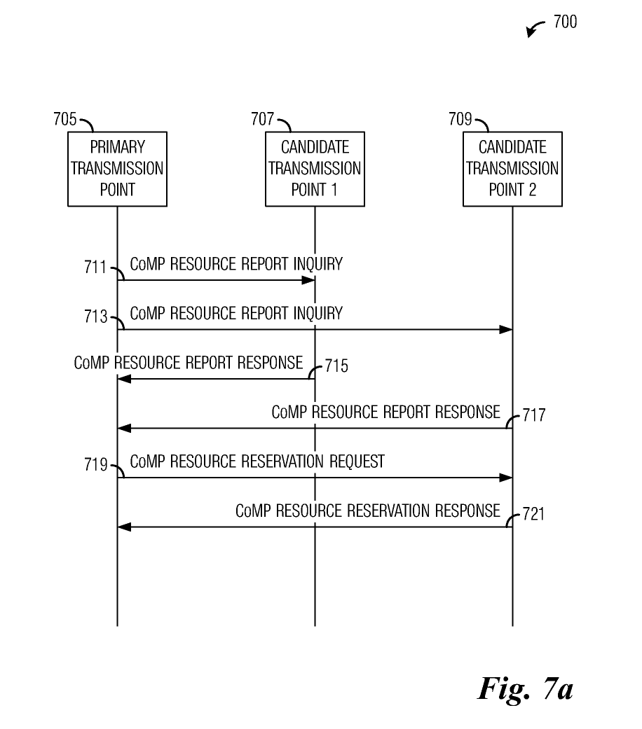

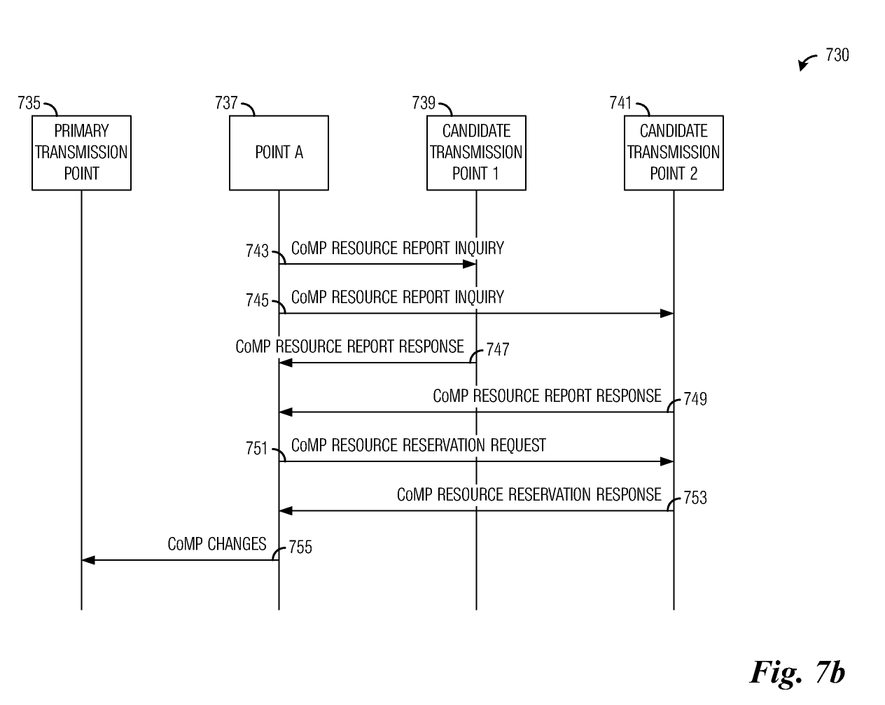

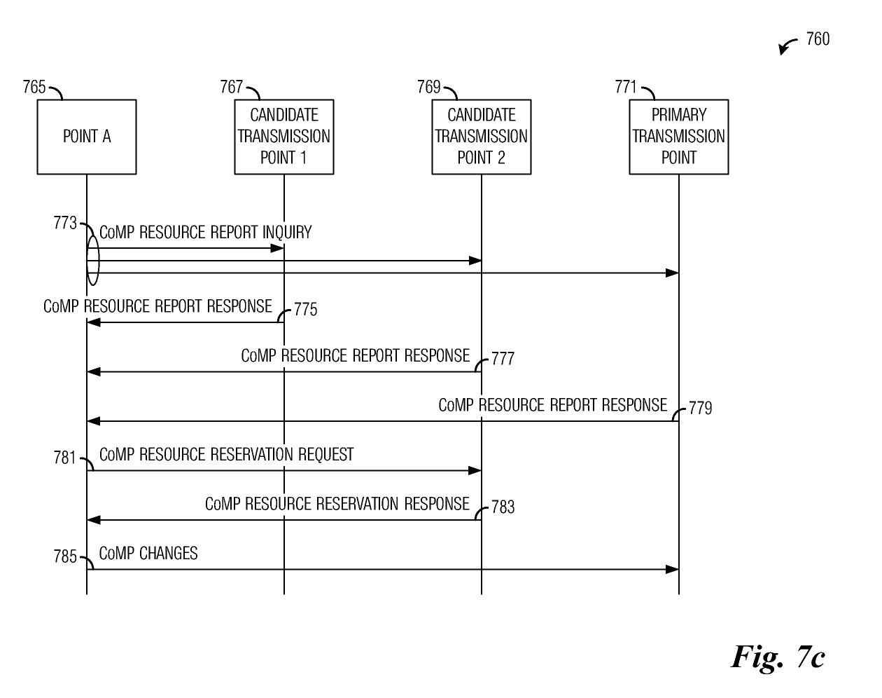

FIG. 7a illustrates a message exchange 700 in confirmation of commitment of upper layer resources in selecting, coordinating, and/or maintaining a multiple point operating set with a primary transmission point performing the selecting, coordinating, and/or maintaining. The multiple point operating set may be a multiple point measurement set, a multiple point cooperating set, or a multiple point transmission point(s) set for either UL or DL. Message exchange 700 involves messages exchanged between a primary transmission point 705 and two candidate transmission points (candidate transmission point 1 707 and candidate transmission point 2 709). Although message exchange 700 is shown as involving two candidate transmission points, a generic message exchange may involve any number of candidate transmission points, such as 1, 2, 3, and the like.

Primary transmission point 705 may initiate confirmation of commitment of upper layer resources in the selecting, coordinating, and/or maintaining of a multiple point operating set by transmitting a solicitation for the upper layer information to the candidate transmission points. According to an example embodiment, primary transmission point 705 solicits the upper layer information (potentially along with the lower layer information, such as the channel condition) by sending a “CoMP Resource Report Inquiry” message to the candidate transmission points. As shown in FIG. 7a, primary transmission point 705 transmits the solicitation to candidate transmission point 1 707 (shown as event 711) and candidate transmission point 2 709 (shown as event 713). It is noted that the candidate transmission points receiving the solicitations may or may not already be in a multiple point operating set.

According to an alternative embodiment, if the candidate transmission points are configured to report their upper layer information at predetermined events, times, or with a predetermined periodicity, then primary transmission point 705 does not need to specifically send the solicitations to the candidate transmission points. As an example, predetermined events include a metric (such as total traffic load of the candidate transmission point, the detected channel condition between the candidate transmission point and the UE, and the like) meeting a metric threshold, a change in a number of UE handled by the candidate transmission point, and the like.

In response to the solicitations from primary transmission point 705 (or at predetermined events, times, or periodicities), the candidate transmission points report their upper layer information to primary transmission point 705. In addition to the upper layer information, the candidate transmission points may send lower layer information. As shown in FIG. 7a, candidate transmission point 1 707 sends its upper layer information as event 715 and candidate transmission point 2 709 sends its upper layer information as event 717. According to an example embodiment, the upper layer information is sent in a “CoMP Resource Report Response” message to primary transmission point 705.

The upper layer information is related to upper layer resources that the candidate transmission points can commit to a multiple point collaboration with primary transmission point 705. According to an example embodiment, the candidate transmission points determine the upper layer resources after evaluating the needs of its own non-multiple point UEs and/or UEs that are operating in multiple point collaborations with other primary transmission points. The upper layer information includes basic components, such as subframe availability, bandwidth, QoS level, multiple point communications scheme categories, multiple point data splitting level options, and the like, as described previously. The upper layer information may include variations of the basic components, such as:
The upper layer information is a blend of several (e.g., two or more) of the above listed forms of upper layer information. As an example, it is possible to blend subframe availability and bandwidth together by reporting bandwidth per subframe for a number of subframes; and
The upper layer information is specified differently for different multiple point communication scheme categories. As an example when CoMP is considered, subframe availability may be different for dynamic point selection as compared to joint transmission.

Primary transmission point 705 processes the upper layer information and selects one or more candidate transmission points. According to an example embodiment, primary transmission point 705 may select the one or more candidate transmission points taking into account the upper layer information provided by the candidate transmission points. As an example, primary transmission point 705 selects the one or more candidate transmission points if the candidate transmission point(s) is able to meet the multiple point transmission requirements of the multiple point operating set, such as subframe availability, bandwidth, QoS requirements, multiple point communications scheme categories, multiple point data splitting level options, and the like. If there are more candidate transmission points capable of meeting the multiple point transmission requirements, then primary transmission point selects as many as needed based on selection criteria, such as candidate transmission point lower layer information, candidate transmission point load, candidate transmission point capacity, candidate transmission point service history, and the like.

Primary transmission point 705 sends a resource reservation request to the one or more selected candidate transmission points. According to an example embodiment, the resource reservation request is in the form of a “CoMP Resource Reservation Request” message and includes upper layer information components that are similar to the upper layer information components provided by the candidate transmission points discussed previously. The upper layer information components in the resource reservation request are related to upper layer resources that need to be committed by the candidate transmission points in collaboration with primary transmission point 705. For discussion purposes, consider a situation wherein primary transmission point 705 selected candidate transmission point 2 709 and transmits the request in event 719.

The one or more selected transmission points either confirms or rejects the request to reserve upper layer resources as specified in the upper layer information components provided by primary transmission point 705 in the resource reservation request. According to an example embodiment, the one or more selected transmission points individually confirms or rejects the request from primary transmission point 705 by sending a response message (a “CoMP Resource Reservation Response” message, for example). As an example, candidate transmission point 2 709 sends the response message in event 721.

If the resource reservation request from primary transmission point 705 is confirmed, a confirmation of commitment of upper layer resources portion of the selecting, coordinating, and/or maintaining of a multiple point operating set completes. Additional portions of the selecting, coordinating, and/or maintaining of the multiple point operating set may proceed.

If the resource reservation request from primary transmission point 705 is rejected, primary transmission point 705 can repeat confirmation of commitment of upper layer resources in the selecting, coordinating, and/or maintaining of a multiple point operating set procedure, potentially with the same upper layer information components and/or values or different upper layer information components and/or values. Furthermore, candidate transmission point 2 709 may send a new or updated resource report to primary transmission point 705. The new or updated resource report may be in the form of a separate message or piggybacked with a previously transmitted response message, such as the response message in event 721.

According to an example embodiment, confirmation of commitment of upper layer resources in the selecting, coordinating, and/or maintaining of a multiple point operating set may continue until a request is confirmed, a number of attempts meets a specified attempt threshold, a time elapsed meets a specified time threshold, and the like.

FIG. 7b illustrates a message exchange 730 in confirmation of commitment of upper layer resources in selecting, coordinating, and/or maintaining a multiple point operating set with a Point A that is not a primary transmission point initiating the procedure. Message exchange 730 involves messages exchanged between a Point A 737, two candidate transmission points (candidate transmission point 1 739 and candidate transmission point 2 741), and a primary transmission point 735. Although message exchange 730 is shown as involving two candidate transmission points, a generic message exchange may involve any number of candidate transmission points, such as 1, 2, 3, and the like.

In general, a Point A is any device that is capable of performing a selecting, coordinating, and/or maintaining of a multiple point operating set. Examples of Point As include a primary transmission point, a secondary transmission point, an eNB, a multiple point controller, a mobility management entity (MME), and the like.

Point A 737 may initiate confirmation of commitment of upper layer resources in the selecting, coordinating, and/or maintaining of a multiple point operating set by transmitting a solicitation (e.g., a “CoMP Resource Report Inquiry” message) for upper layer information to the candidate transmission points (shown as event 743 and event 745, respectively). According to an alternative embodiment, if the candidate transmission points are configured to report their upper layer information at predetermined events, times, or with a predetermined periodicity, then Point A 737 does not need to specifically send the solicitations to the candidate transmission points.

In response to the solicitations from Point A 737 (or at predetermined events, times, or periodicities), the candidate transmission points report (e.g., in a “CoMP Resource Report Response” message) their upper layer information to Point A 737 (shown as event 747 and event 749). In addition to the upper layer information, the candidate transmission points may send lower layer information.

Point A 737 processes the upper layer information and selects one or more candidate transmission points. According to an example embodiment, Point A 737 selects the one or more candidate transmission points based on the upper layer information provided by the candidate transmission points. Point A 737 sends a resource reservation request (e.g., a “CoMP Resource Reservation Request” message) to the one or more selected candidate transmission points. As an example, Point A 737 sends the request to candidate transmission point 2 741 (shown as event 751).

The one or more selected transmission points either confirms or rejects the resource reservation request from Point A 737. The confirmation or rejection may be sent to Point A 737 in the form of a “CoMP Resource Reservation Response” message (shown as event 753). For discussion purposes, consider a situation wherein candidate transmission point 2 741 confirms the request from Point A 737. In such a situation, Point A 737 completes confirmation of commitment of upper layer resources in the selecting, coordinating, and/or maintaining of a multiple point operating set with the change to the multiple point operating set and sends information related to changes in the multiple point operating set to primary transmission point 735, e.g., in a “CoMP Changes” message (shown as event 755).

However, if the one or more selected transmission points reject the request from Point A 737, Point A 737 repeats confirmation of commitment of upper layer resources in the selecting, coordinating, and/or maintaining of a multiple point operating set by sending the solicitation for upper layer information and resource reservation request until a resulting resource reservation request is confirmed or Point A 737 terminates confirmation of commitment of upper layer resources in the selecting, coordinating, and/or maintaining of a multiple point operating set due to an elapsing of an attempts counter, a time elapsed counter, and the like.

FIG. 7c illustrates a message exchange 760 in confirmation of commitment of upper layer resources in selecting, coordinating, and/or maintaining a multiple point operating set with a Point A that is not a primary transmission point initiating the procedure. Message exchange 760 involves messages exchanged between a Point A 765, and three candidate transmission points (candidate transmission point 1 767, candidate transmission point 2 769, and a primary transmission point 771). Although message exchange 760 is shown as involving three candidate transmission points, a generic message exchange may involve any number of candidate transmission points, such as 1, 2, 3, and the like.

Point A 765 may initiate confirmation of commitment of upper layer resources in the selecting, coordinating, and/or maintaining of a multiple point operating set by transmitting a solicitation (e.g., a “CoMP Resource Report Inquiry” message) for upper layer information to the candidate transmission points (shown collectively as events 773). According to an alternative embodiment, if the candidate transmission points are configured to report its upper layer information at predetermined events, times, or with a predetermined periodicity, then Point A 765 does not need to specifically send the solicitations to the candidate transmission points.

In response to the solicitations from Point A 765 (or at predetermined events, times, or periodicities), the candidate transmission points report (e.g., in a “CoMP Resource Report Response” message) their upper layer information to Point A 765 (shown as event 775, event 777, and event 779). In addition to the upper layer information, the candidate transmission points may send lower layer information.

Point A 765 processes the upper layer information and selects one or more candidate transmission points. According to an example embodiment, Point A 765 selects the one or more candidate transmission points based on the upper layer information provided by the candidate transmission points. Point A 765 sends a resource reservation request (e.g., a “CoMP Resource Reservation Request” message) to the one or more selected candidate transmission points. As an example, Point A 765 sends the request to candidate transmission point 2 769 (shown as event 781).

The one or more selected transmission points either confirms or rejects the resource reservation request from Point A 765. The confirmation or rejection may be sent to Point A 765 in the form of a “CoMP Resource Reservation Response” message (shown as event 783). For discussion purposes, consider a situation wherein candidate transmission point 2 769 confirms the request from Point A 765. In such a situation, Point A 765 completes confirmation of commitment of upper layer resources in the selecting, coordinating, and/or maintaining of a multiple point operating set with the change to the multiple point operating set and sends information related to changes in the multiple point operating set to primary transmission point 771 (shown as event 785). According to an example embodiment, the changes in the multiple point operating set is sent to primary transmission point 771 in a “CoMP Changes” message, which comprises upper layer information components related to the changes in the multiple point operating set.

According to an example embodiment, primary transmission point 771 may be a transmission point among the one or more selected transmission points. Therefore Point A 765 may perform a resource reservation message exchange with primary transmission point 771 (i.e., a “CoMP Resource Reservation Request” message to primary transmission point 771 and a “CoMP Resource Reservation Response” message from primary transmission point 771). The resource reservation request exchange generally occurs before informing primary transmission point 771 of the changes in the multiple point operating set (event 785).

However, if the one or more selected transmission points rejects the request from Point A 765, Point A 765 may repeat the solicitation for upper layer information and the transmission of resource reservation request until a resulting resource reservation request is confirmed or Point A 765 terminates confirmation of commitment of upper layer resources in the selecting, coordinating, and/or maintaining of a multiple point operating set due to an elapsing of an attempts counter, a time elapsed counter, and the like.

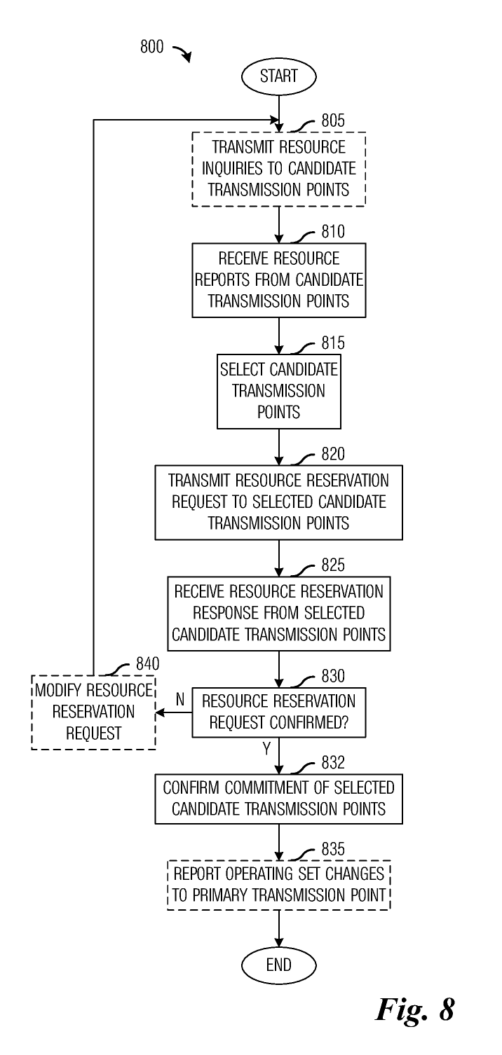

FIG. 8 illustrates a flow diagram of operations 800 in a Point A as the Point A participates in confirmation of commitment of upper layer resources in selecting, coordinating, and/or maintaining a multiple point operating set. Operations 800 may be indicative of operations occurring in a Point A, such as a primary transmission point, a secondary transmission point, an eNB, a multiple point controller, a mobility management entity (MME), and the like, as the Point A participates in confirmation of commitment of upper layer resources in selecting, coordinating, and/or maintaining a multiple point operating set.

Operations 800 may begin with the Point A transmitting resource inquiries (solicitations) for upper layer information to candidate transmission points (which may include a primary transmission point) to initiate selecting, coordinating, and/or maintaining a multiple point operating set (block 805). According to an example embodiment, the resource inquiries inquire about the candidate transmission points' upper layer resource availability for multiple point operation. It is noted that block 805 may be an optional operation if the candidate transmission points are configured to report their upper layer information at predetermined events, times, or with a predetermined periodicity.

The Point A receives resource reports from the candidate transmission points (block 810). As discussed above, the resource reports from the candidate transmission points may be in response to the resource inquiries or prescheduled. According to an example embodiment, the resource reports contain upper layer information regarding upper layer resources that the candidate transmission points are willing to assign to multiple point operation with the Point A. The resource reports may also contain lower layer information.

The Point A uses the resource reports from the candidate transmission points to select one or more candidate transmission points (block 815). According to an example embodiment, the Point A selects the one or more candidate transmission points depending on the upper layer information (as well as other information such as lower layer information provided by the candidate transmission points or received from other sources). As an example, the Point A selects the one or more candidate transmission points from the candidate transmission points that reported upper layer information (and potentially lower layer information) that meets the multiple point operation requirements. If none or an insufficient number of the candidate transmission points report upper layer information that meet the multiple point operation requirements, then the Point A may repeat the resource inquiries with the same or different candidate transmission points or modify the multiple point operation requirements.

The Point A sends resource reservation requests to the one or more selected candidate transmission points (block 820). According to an example embodiment, the resource reservation requests include upper layer information that the Point A requests a respective selected candidate transmission point reserve for the multiple point operations.

The one or more selected candidate transmission points sends their response (e.g., either a confirmation or a rejection) to the resource reservation requests from the Point A and sends their response to the Point A. The Point A receives the response from the one or more selected candidate transmission points (block 825). If the one or more selected candidate transmission points confirmed the resource reservation request (block 830), then confirmation of commitment of upper layer resources in the selecting, coordinating, and/or maintaining of a multiple point operating set is made (block 832). Optionally, if the Point A is not the primary transmission point for the multiple point operation, then the Point A sends a report about changes to the multiple point operating set to the primary transmission point (block 835).

If the one or more selected candidate transmission points rejected the resource reservation request (block 830), the Point A returns to block 805 (an optional operation depending upon a configuration of the candidate transmission points) or block 810 to repeat confirmation of commitment of upper layer resources in the selecting, coordinating, and/or maintaining of a multiple point operating set procedure, potentially with the same upper layer information components and/or values or different upper layer information components and/or values (i.e., modify the resource reservation request (block 840)).

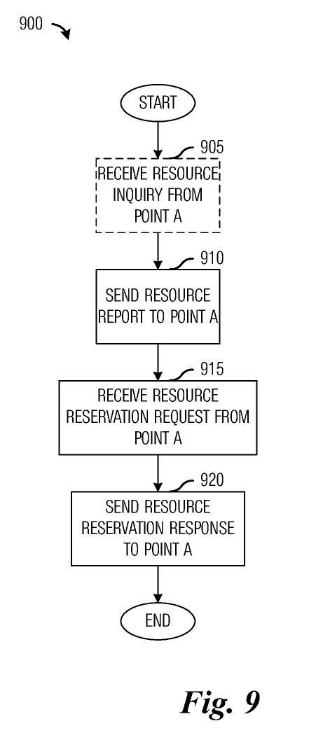

FIG. 9 illustrates a flow diagram of operations 900 in a candidate transmission point as the candidate transmission point participates in confirmation of commitment of upper layer resources in selecting, coordinating, and/or maintaining a multiple point operating set. Operations 900 may be indicative of operations occurring in a candidate transmission point, such as a primary transmission point, a secondary transmission point, a transmission point, and the like, as the candidate transmission point participates in confirmation of commitment of upper layer resources in the selecting, coordinating, and/or maintaining of a multiple point operating set.

Operations 900 begin with the candidate transmission point receiving a resource inquiry (a solicitation) from a Point A (block 905). According to an example embodiment, the resource inquiry inquires about the candidate transmission point's upper layer resource availability for multiple point operation. It is noted that block 905 may be an optional operation if the candidate transmission point is configured to report its upper layer information at predetermined events, times, or with a predetermined periodicity.

The candidate transmission point determines its upper layer resource availability for multiple point operation and sends a resource report to the Point A (block 910). According to an example embodiment, the candidate transmission point checks its available upper layer resources and selects some upper layer resources from the available upper layer resources as the upper layer resources that it is willing to dedicate (or commit) to multiple point operation.

The candidate transmission point receives a resource reservation request from the Point A, which indicates that the Point A requests the candidate transmission point to reserve the specified amount of upper layer resources to participate in multiple point operation (block 915). The candidate transmission point may either confirm (agree to participate in multiple point operation with at least the amount of upper layer resource specified in the resource reservation request) or reject (do not commit the amount of upper layer resource specified in the resource reservation request for participating in multiple point operation) the resource reservation request. The candidate transmission point sends its response to the resource reservation request to the Point A (block 920).

In the above discussion, a primary transmission point or a Point A initiates the selecting, coordinating, and/or maintaining of a multiple point operating set. According to an example embodiment, it is also possible for a candidate transmission point or an existing transmission point to initiate selecting, coordinating, and/or maintaining a multiple point operating set.

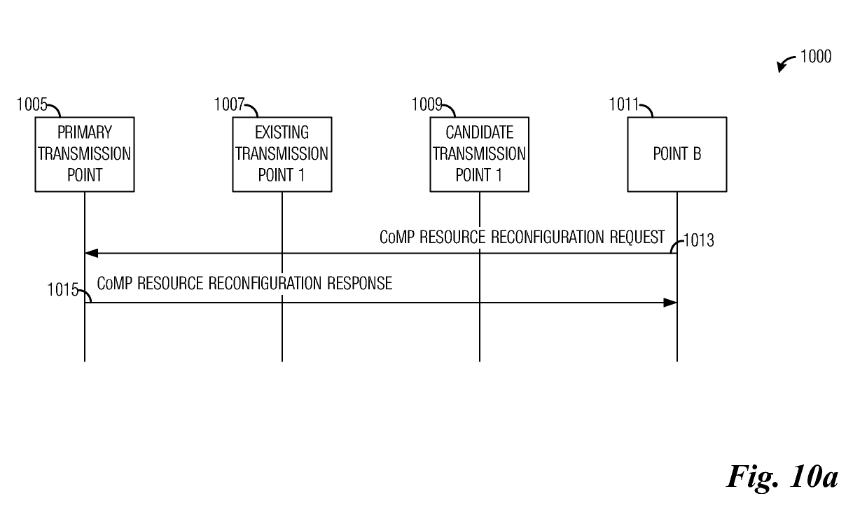

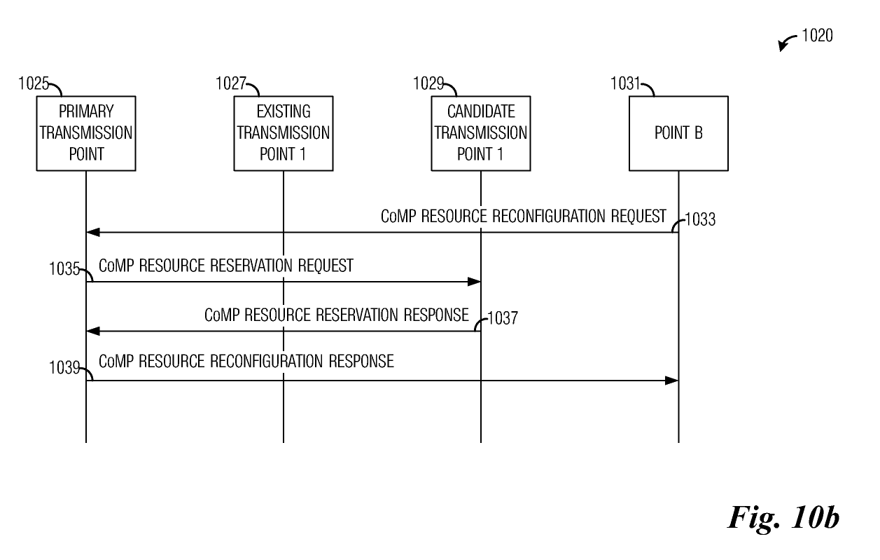

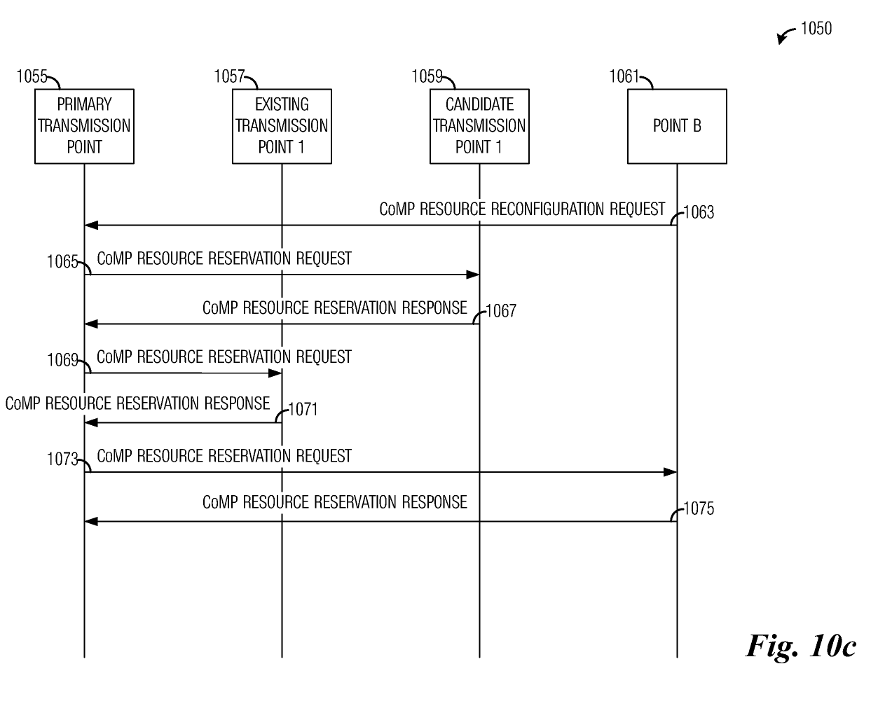

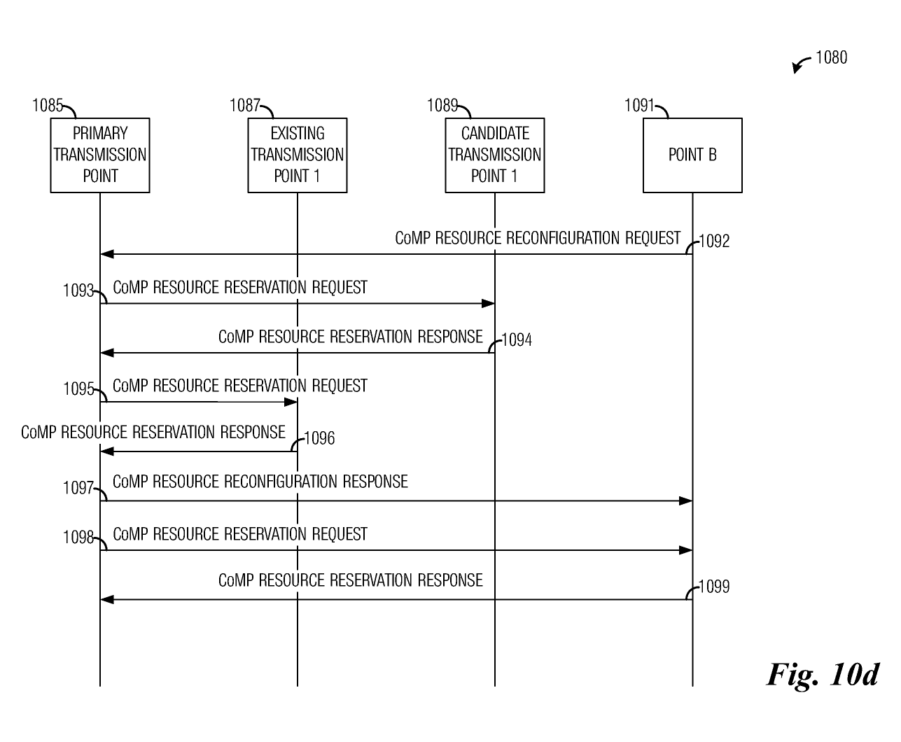

FIG. 10a illustrates a message exchange 1000 in confirmation of commitment of upper layer resources in selecting, coordinating, and/or maintaining a multiple point operating set with a Point B initiating confirmation of commitment of upper layer resources in the selecting, coordinating, and/or maintaining of a multiple point operating set, wherein the Point B is an existing transmission point. Message exchange 1000 involves messages exchanged between a primary transmission point 1005 and other transmission points (e.g., existing transmission point 1 1007, candidate transmission point 1 1009, and Point B 1011). Although message exchange 1000 is shown as involving three transmission points (and primary transmission point 1005), a typical message exchange may involve any number of transmission points, such as 1, 2, 3, 4, and the like. Although the discussion presented herein describes message exchange 1000 as involving primary transmission point 1005, example embodiments are operable with message exchange 1000 involving a Point A rather than primary transmission point 1005. Therefore, discussion of primary transmission point 1005 should not be construed as being limiting to either the scope or the spirit of the example embodiments.

Point B 1011 may initiate confirmation of commitment of upper layer resources in the selecting, coordinating, and/or maintaining of a multiple point operating set by sending a reconfiguration request to primary transmission point 1005 (shown as event 1013). According to an example embodiment, the Point B 1011 initiates confirmation of commitment of upper layer resources in the selecting, coordinating, and/or maintaining of a multiple point operating set by sending a “CoMP Resource Reconfiguration Request” message to primary transmission point 1005. The reconfiguration request includes upper layer information, specifying a change in the upper layer resources that Point B 1011 wishes to provide for multiple point operation.

If the change in the upper layer resources can be satisfied by primary transmission point 1005 without impacting other transmission points, primary transmission point 1005 satisfies the change in the upper layer resources by itself and sends a response to Point B 1011 (shown as event 1015). According to an example embodiment, primary transmission point 1005 responds to Point B 1011 by sending a “CoMP Resource Reconfiguration Response” message. The response includes an indication that the resource reconfiguration request from Point B 1011 can be satisfied.

FIG. 10b illustrates a message exchange 1020 in confirmation of commitment of upper layer resources in selecting, coordinating, and/or maintaining a multiple point operating set with a Point B initiating confirmation of commitment of upper layer resources in the selecting, coordinating, and/or maintaining of a multiple point operating set, wherein the Point B is an existing transmission point. Message exchange 1020 involves messages exchanged between a primary transmission point 1025 and other transmission points (e.g., existing transmission point 1 1027, candidate transmission point 1 1029, and Point B 1031). Although message exchange 1020 is shown as involving three transmission points (and primary transmission point 1025), a typical message exchange may involve any number of transmission points, such as 1, 2, 3, 4, and the like. Although the discussion presented herein describes message exchange 1020 as involving primary transmission point 1025, example embodiments are operable with message exchange 1020 involving a Point A rather than primary transmission point 1025. Therefore, discussion of primary transmission point 1025 should not be construed as being limiting to either the scope or the spirit of the example embodiments.

Point B 1031 may initiate confirmation of commitment of upper layer resources in the selecting, coordinating, and/or maintaining of a multiple point operating set by sending a reconfiguration request to primary transmission point 1025 (shown as event 1033). According to an example embodiment, the Point B 1031 initiates the selecting, coordinating, and/or maintaining of a multiple point operating set by sending a “CoMP Resource Reconfiguration Request” message to primary transmission point 1025. The reconfiguration request includes upper layer information specifying a change in the upper layer resources that Point B 1031 wishes to provide for multiple point operation.

If the change in the upper layer resources can not be satisfied by primary transmission point 1025 without impacting other transmission points, primary transmission point 1025 selects one or more of the other transmission points, e.g., candidate transmission point 1 1029, based on upper layer information from the candidate transmission points and sends a resource reservation request to the one or more selected transmission points to modify the multiple point operation configuration of the one or more selected transmission points (shown as event 1035). In general, when primary transmission point 1025 is not capable of satisfying the change in the upper layer resources by itself, primary transmission point 1025 considers reconfiguration of existing transmission points (such as existing transmission point 1 1027) and/or candidate transmission points (such as candidate transmission point 1 1029). According to an example embodiment, primary transmission point 1025 sends the resource reservation request by sending a “CoMP Resource Reservation Request” message to the one or more selected transmission points. The resource reservation request includes new or updated upper layer information that the primary transmission point 1025 requests the one or more selected transmission points to reserve for the multiple point operations due to the change in the upper layer resources of Point B 1031 specified in the resource reconfiguration request (event 1033).

The one or more selected transmission points, e.g., candidate transmission point 1 1029, sends a response to the resource reservation request from primary transmission point 1025 (shown as event 1037). According to an example embodiment, the response is in the form of a “CoMP Resource Reservation Response” message and includes a confirmation or a rejection of the change to the multiple point operation resource configuration for the one or more selected transmission points.

For discussion purposes, considering a situation wherein the one or more selected transmission points confirmed that the change to the multiple point operation resource configuration is acceptable, then primary transmission point 1025 completes the change to the multiple point operation resource configuration and sends a response to Point B 1031 confirming the change (shown as event 1039). According to an example embodiment, the response is in the form of a “CoMP Resource Reconfiguration Response” message and includes an indication of the acceptance of the change to the multiple point operation resource configuration.

FIG. 10c illustrates a message exchange 1050 in confirmation of commitment of upper layer resources in selecting, coordinating, and/or maintaining a multiple point operating set with a Point B initiating confirmation of commitment of upper layer resources in the selecting, coordinating, and/or maintaining of a multiple point operating set, wherein the Point B is an existing transmission point. Message exchange 1050 involves messages exchanged between a primary transmission point 1055 and other transmission points (e.g., existing transmission point 1 1057, candidate transmission point 1 1059, and Point B 1061). Although message exchange 1050 is shown as involving three transmission points (and primary transmission point 1055), a typical message exchange may involve any number of transmission points, such as 1, 2, 3, 4, and the like. Although the discussion presented herein describes message exchange 1050 as involving primary transmission point 1055, example embodiments are operable with message exchange 1050 involving a Point A rather than primary transmission point 1055. Therefore, discussion of primary transmission point 1055 should not be construed as being limiting to either the scope or the spirit of the example embodiments.

Point B 1061 may initiate confirmation of commitment of upper layer resources in the selecting, coordinating, and/or maintaining of a multiple point operating set by sending a reconfiguration request to primary transmission point 1055 (shown as event 1063). According to an example embodiment, the Point B 1061 initiates confirmation of commitment of upper layer resources in the selecting, coordinating, and/or maintaining of a multiple point operating set by sending a “CoMP Resource Reconfiguration Request” message to primary transmission point 1055. The reconfiguration request includes upper layer information specifying a change in the upper layer resources that Point B 1061 wishes to provide for multiple point operation.

If the change in the upper layer resources can not be satisfied by primary transmission point 1055 without impacting other transmission points, primary transmission point 1055 selects one or more of the other transmission points, e.g., candidate transmission point 1 1059, based on upper layer information from the transmission points and sends a resource reservation request to the one or more selected transmission points to modify the multiple point operation resource configuration of the one or more selected transmission points (shown as event 1065). According to an example embodiment, primary transmission point 1055 sends the resource reservation request by sending a “CoMP Resource Reservation Request” message to the one or more selected transmission points. The request includes new or updated upper layer information that primary transmission point 1055 requests the one or more selected transmission points to reserve for the multiple point operations due to the change in the upper layer resources of Point B 1061 specified in the resource reconfiguration request (event 1063).

The one or more selected transmission points, e.g., candidate transmission point 1 1059, sends a response to the resource reservation request from primary transmission point 1055 (shown as event 1067). According to an example embodiment, the response is in the form of a “CoMP Resource Reservation Response” message and includes a confirmation or a rejection of the change to the multiple point operation resource configuration for the one or more selected transmission points.

For discussion purposes, considering a situation wherein the one or more selected transmission points rejected the change to the multiple point operation resource configuration (i.e., the change to the amount of upper layer resources that the one or more selected transmission points needs to commit for the multiple point operation is not acceptable), then primary transmission point 1055 selects one or more alternative transmission points, e.g., existing transmission point 1 1057, based on upper layer information from the transmission points and sends a resource reservation request to the one or more selected alternate transmission points to modify the multiple point operation resource configuration of the one or more selected alternate transmission points (shown as event 1069). According to an example embodiment, primary transmission point 1055 sends the resource reservation request by sending a “CoMP Resource Reservation Request” message to the one or more selected alternate transmission points. The request includes new or updated upper layer information that the primary transmission point 1055 requests the one or more selected alternate transmission points to reserve for the multiple point operations due to the change in the upper layer resources of Point B 1061 specified in the resource reconfiguration request (event 1063).

The one or more selected alternate transmission points, e.g., existing transmission point 1 1057, sends a response to the resource reservation request from primary transmission point 1055 (shown as event 1071). According to an example embodiment, the response is in the form of a “CoMP Resource Reservation Response” message and includes a confirmation or a rejection of the change to the multiple point operation resource configuration for the one or more selected alternate transmission points.

For discussion purposes, considering a situation wherein the one or more selected alternate transmission points rejected the change to the multiple point operation resource configuration (i.e., the change to the amount of upper layer resources that the one or more selected alternate transmission points needs to commit for the multiple point operation is not acceptable), then primary transmission point 1055, after exhausting the possible communications points, may perform a change procedure to negotiate a change in upper layer resources with Point B 1061 (shown as events 1073). According to an example embodiment, the change procedure is initiated with a “CoMP Resource Reservation Request” message sent to Point B 1061. According to an example embodiment, Point B 1061 responds with a “CoMP Resource Reservation Response” message (shown as event 1075) to either confirm or reject the negotiation of the change in upper layer resources. According to another example embodiment, the initiation of the change procedure provides an implicit rejection of the reconfiguration request sent by Point B 1061 in event 1063.

For discussion purposes, considering a situation wherein the one or more selected transmission points did not accept the change to the multiple point operation resource configuration in its entirety (e.g., the one or more selected transmission points did not accept all of the change to the multiple point operation resource configuration). Primary transmission point 1055 may partition the change to the multiple point operation resource configuration and assign a part that is acceptable to the one or more selected transmission points to the one or more selected transmission points and then negotiate a remainder of the change to the multiple point operation resource configuration with alternate selected transmission point(s).

FIG. 10d illustrates a message exchange 1080 in confirmation of commitment of upper layer resources in selecting, coordinating, and/or maintaining a multiple point operating set with a Point B initiating confirmation of commitment of upper layer resources in the selecting, coordinating, and/or maintaining of a multiple point operating set, wherein the Point B is an existing transmission point. Message exchange 1080 involves messages exchanged between a primary transmission point 1085 and other transmission points (e.g., existing transmission point 1 1087, candidate transmission point 1 1089, and Point B 1091). Although message exchange 1080 is shown as involving three candidate transmission points (and primary transmission point 1085), a typical message exchange may involve any number of candidate transmission points, such as 1, 2, 3, 4, and the like. Although the discussion presented herein describes message exchange 1080 as involving primary transmission point 1085, example embodiments are operable with message exchange 1080 involving a Point A rather than primary transmission point 1085. Therefore, discussion of primary transmission point 1085 should not be construed as being limiting to either the scope or the spirit of the example embodiments.

Point B 1091 may initiate confirmation of commitment of upper layer resources in the selecting, coordinating, and/or maintaining of a multiple point operating set by sending a reconfiguration request to primary transmission point 1085 (shown as event 1092). According to an example embodiment, the Point B 1091 initiates confirmation of commitment of upper layer resources in the selecting, coordinating, and/or maintaining of a multiple point operating set by sending a “CoMP Resource Reconfiguration Request” message to primary transmission point 1085. The reconfiguration request includes upper layer information specifying a change in the upper layer resources that Point B 1091 wishes to provide for multiple point operation.

If the change in the upper layer resources can not be satisfied by primary transmission point 1085 without impacting other transmission points, primary transmission point 1085 selects one or more of the other transmission points, e.g., candidate transmission point 1 1089, based on upper layer information from the transmission points and sends a resource reservation request to the one or more selected transmission points to modify the multiple point operation resource configuration of the one or more selected transmission points (shown as event 1093). According to an example embodiment, primary transmission point 1085 sends the resource reservation request by sending a “CoMP Resource Reservation Request” message to the one or more selected transmission points. The request includes new or updated upper layer information that primary transmission point 1085 requests the one or more selected transmission points to reserve for multiple point operation due to the change in the upper layer resources of Point B 1091 specified in the resource reconfiguration request (event 1092).

The one or more selected transmission points, e.g., candidate transmission point 1 1089, sends a response to the resource reservation request from primary transmission point 1085 (shown as event 1094). According to an example embodiment, the response is in the form of a “CoMP Resource Reservation Response” message and includes a confirmation or a rejection of the change to the multiple point operation resource configuration for the one or more selected transmission points.

For discussion purposes, considering a situation wherein the one or more selected transmission points rejected the change to the multiple point operation resource configuration (i.e., the change to the amount of upper layer resources that the one or more selected transmission points needs to commit for the multiple point operation is not acceptable), then primary transmission point 1085 selects one or more alternative candidate transmission points, e.g., transmission point 1 1087, based on upper layer information from the transmission points and sends a resource reservation request to the one or more selected alternate transmission points to modify the multiple point operation resource configuration of the one or more selected alternate transmission points (shown as event 1095). According to an example embodiment, primary transmission point 1085 sends the resource reservation request by sending a “CoMP Resource Reservation Request” message to the one or more selected alternate transmission points. The request includes new or updated upper layer information that the primary transmission point 1085 requests the one or more selected alternate transmission points to reserve for the multiple point operations due to the change in the upper layer resources of Point B 1091 specified in the resource reconfiguration request (event 1092).

The one or more selected alternate transmission points, e.g., transmission point 1 1087, sends a response to the resource reservation request from primary transmission point 1085 (shown as event 1096). According to an example embodiment, the response is in the form of a “CoMP Resource Reservation Response” message and includes a confirmation or a rejection of the change to the multiple point operation resource configuration for the one or more selected alternate transmission points.

For discussion purposes, considering a situation wherein the one or more selected alternate transmission points rejected the change to the multiple point operation configuration (i.e., the change to the amount of upper layer resources that the one or more selected alternate transmission points needs to commit for the multiple point operation is not acceptable), then primary transmission point 1085, after exhausting the possible communications points, may send a resource reconfiguration response message containing a rejection of the resource reconfiguration request to Point B 1091 (shown as event 1097). According to an example embodiment, the resource reconfiguration response message is in the form of a “CoMP Resource Reconfiguration Response” message.

Primary transmission point 1085 may perform a change procedure to negotiate a change in upper layer resources with Point B 1091 (shown as events 1098). According to an example embodiment, the change procedure is initiated with a “CoMP Resource Reservation Request” message sent to Point B 1091. Point B 1091 responds with a “CoMP Resource Reservation Response” message (shown as event 1099) to either confirm or reject the negotiation of the change in upper layer resources.

For discussion purposes, considering a situation wherein the one or more selected transmission points did not accept the change to the multiple point operation resource configuration in its entirety (e.g., the one or more selected transmission points did not accept all of the change to the multiple point operation resource configuration). Primary transmission point 1085 may partition the change to the multiple point operation resource configuration and assign a part that that is acceptable to the one or more selected transmission points to the one or more selected transmission points and then negotiate a remainder of the change to the multiple point operation resource configuration with alternate selected transmission point(s).

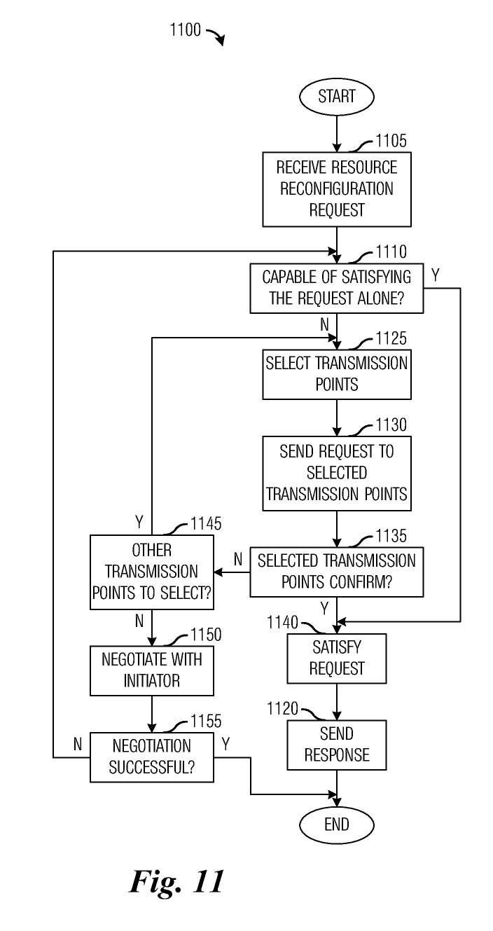

FIG. 11 illustrates a flow diagram of operations 1100 in a primary transmission point as the primary transmission point participates in a Point B initiated confirmation of commitment of upper layer resources in selecting, coordinating, and/or maintaining a multiple point operating set. Operations 1100 may be indicative of operations occurring in a primary transmission point as the transmission point responds to a Point B initiated confirmation of commitment of upper layer resources in selecting, coordinating, and/or maintaining of a multiple point operating set.

Operations 1100 may begin with the primary transmission point receiving a resource reconfiguration request from the Point B, which initiates confirmation of commitment of upper layer resources in the selecting, coordinating, and/or maintaining of a multiple point operating set (block 1105). According to an example embodiment, the primary transmission point processes the change in the upper layer resources as requested by the Point B and performs a check to determine if it is capable of satisfying the resource reconfiguration request alone (block 1110).

If the primary transmission point is capable of satisfying the resource reconfiguration request alone, then the primary transmission point satisfies the resource reconfiguration request (block 1140) and sends a response, e.g., a resource reconfiguration response, to the Point B (block 1120).

If the primary transmission point is not capable of satisfying the resource reconfiguration request alone, then the primary transmission point selects one or more transmissions points that based on upper layer information provided by the transmission points might be able to support the resource reconfiguration request (block 1125) and sends a resource reservation request to the one or more selected transmission points (block 1130).

The primary transmission point receives responses to the resource reservation request from the one or more selected transmission points and performs a check to determine if the one or more selected transmission points confirm the resource reservation request (block 1135). If the one or more selected transmission points confirm the resource reservation request, the primary transmission point completes the satisfying of the resource reconfiguration request (block 1140) and sends a response, e.g., a resource reconfiguration response, to the Point B (block 1120).

If the one or more selected transmission points reject the resource reservation request, the primary transmission point performs a check to determine if there are additional transmission points to select (block 1145). If there are additional transmission points to select, the primary transmission point returns to block 1125 to select additional transmission point(s).

If there are no other transmission points to select (block 1145), then the primary transmission point negotiates with the Point B (block 1150). According to an example embodiment, the primary transmission point negotiates with the Point B to determine whether the Point B may accept an updated commitment of upper layer communication resources as specified, e.g., by transmitting an updated resource reservation request message for the Point B. It is noted that the amount of upper layer resources specified in the updated resource reservation request is different from the change that Point B requested in its earlier resource reconfiguration request (e.g., the primary transmission point's updated resource reservation request asks the Point B to reduce the amount of resource change requested in Point B's reconfiguration request).

The primary transmission point performs a check to determine if the negotiation with the Point B is successful (block 1155). The negotiation is considered not successful if the Point B does not accept entirely the updated commitment of upper layer communications resource specified by the primary point. If the negotiation is successful, operations 1100 ends. If the negotiation is not successful, Point B may choose to update its resource reconfiguration request with adjusted change in the upper layer resources commitment, or insist its original resource reconfiguration request. The primary transmission point returns to block 1110 to determine if it or other transmission points can satisfy the latest resource reconfiguration request of Point B.

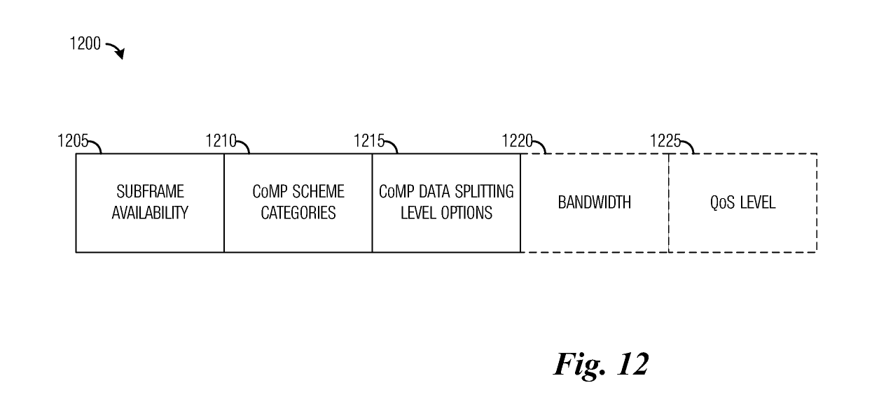

FIG. 12 illustrates a message 1200. Message 1200 is used to carry upper layer information in the form of upper layer information components. Message 1200 may carry upper layer information or changes to upper layer information for an existing communication point or a candidate communication point of multiple point operation configuration. Message 1200 may be sent by a network entity, such as a multiple point controller, a primary communication point, a secondary communication point, a MME, and the like, to provide upper layer information to an intended recipient, which may be another network entity such as those listed above.

Message 1200 may include a subframe availability field 1205 that specifies information about subframes during which multiple point transmission and/or reception is allowed. Subframe availability is usable by the entity to evaluate potential latency that may be incurred. It is noted that it is possible that not all subframes will be available for multiple point operation due to restrictions such as almost blank subframe (ABS) operation, backhaul link/access link (Un/Uu) subframes, multimedia broadcast-multicast service (MBMS) subframes, as well as those subframes that are reserved for other uses, such as a transmission point's own UEs and routine operations.

Message 1200 may also include a multiple point communication scheme categories field 1210 that specifies multiple point communications scheme categories supported by a communication point. As an example, for CoMP operation, a transmission point may specify different CoMP categories (such as dynamic point selection, joint transmission, joint processing, coordinated scheduling/beamforming, and the like).

Message 1200 may also include a multiple point communication data splitting level options field 1215 that specifies multiple point communications data splitting level options supported by a communication point. As an example, for CoMP operation, a transmission point may specify different CoMP data splitting levels (such as MAC level, RLC level, PDCP level, and the like).

Message 1200 may also include a bandwidth field 1220 that specifies information about bandwidth that is available for allocation for multiple point transmission and/or reception. The bandwidth may be specified in terms of a maximum value, a minimum value, or an average value that is available over a specified time window.

Message 1200 may further include a Quality of Service (QoS) level field 1225 that specifies information about a QoS requirement that the multiple point traffic should meet so that the transmission and/or reception of the multiple point traffic can be committed by a communications point. A communication point may be willing to use its resources for multiple point operation only to multiple point traffic of importance, e.g., the QoS level and/or priority of the traffic exceeding a specified threshold.

According to an example embodiment, message 1200 is used to send upper layer information in response to a solicitation for upper layer information, e.g., a CoMP Resource Report Response message. According to another example embodiment, message 1200 is used to send upper layer information requirements in a resource reservation request, e.g., a CoMP Resource Reservation Request message. Message 1200 may also include low layer information, such as channel information, and/or other information. In addition, message 1200 may be embedded into other messages.

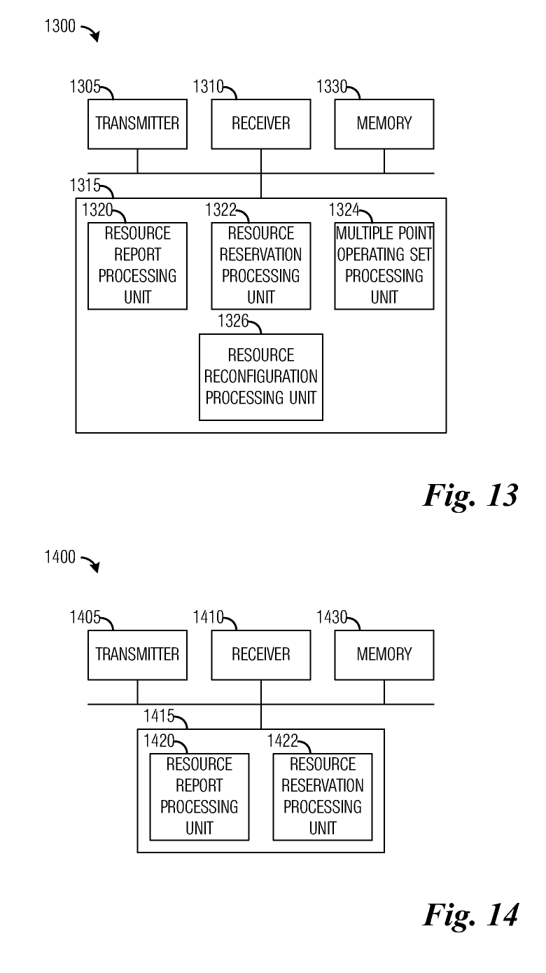

FIG. 13 provides an illustration of a communications device 1300. Communications device 1300 may be an implementation of a communications point, a Point A, a Point B, an eNB, a BS, a RRH, a multiple point controller, a MME, and the like. Communications device 1300 may be used to implement various ones of the embodiments discussed herein. As shown in FIG. 13, a transmitter 1305 is configured to send packets and a receiver 1310 is configured to receive packets. Transmitter 1305 and receiver 1310 may have a wireless interface, a wireline interface, or a combination thereof.

A resource report processing unit 1320 is configured to solicit resource reports from communication points in a multiple point operating set. Resource report processing unit 1320 is also configured to process received resource reports from the communication points. Resource report processing unit 1320 is also configured to select communication points to which resource reservation request will be sent based on the resource reports received from the communication points. A resource reservation processing unit 1322 is configured to generate resource reservation requests to send to selected communication point(s). Resource reservation processing unit 1322 is also configured to process responses from the selected communication point(s).

A multiple point operating set processing unit 1324 is configured to make adjustments to a multiple point operating set based on the resource reports, the reservation requests, and the responses to the reservation requests. A resource reconfiguration processing unit 1326 is configured to process resource reconfiguration requests from a communication point and determines if the resource reconfiguration requests can be satisfied and which devices can satisfy the resource reconfiguration requests. A memory 1330 is configured to store resource reports, multiple point operating sets, reservation requests, selected communication points, resource reconfiguration requests, and the like.

The elements of communications device 1300 may be implemented as specific hardware logic blocks. In an alternative, the elements of communications device 1300 may be implemented as software executing in a processor, controller, application specific integrated circuit, and the like. In yet another alternative, the elements of communications device 1300 may be implemented as a combination of software and/or hardware.

As an example, transmitter 1305 and receiver 1310 may be implemented as a specific hardware block, while resource report processing unit 1320, resource reservation processing unit 1322, multiple point operating set processing unit 1324, and resource reconfiguration processing unit 1326 may be software modules executing in a processor 1315, a microprocessor, a custom circuit, or a custom compiled logic array of a field programmable logic array.

FIG. 14 provides an illustration of a communications device 1400. Communications device 1400 may be an implementation of a transmission point, a Point A, a Point B, an eNB, a BS, a RRH, a multiple point controller, a MME, and the like. Communications device 1400 may be used to implement various ones of the embodiments discussed herein. As shown in FIG. 14, a transmitter 1405 is configured to send packets and a receiver 1410 is configured to receive packets. Transmitter 1405 and receiver 1410 may have a wireless interface, a wireline interface, or a combination thereof.

A resource report processing unit 1420 is configured to process resource report solicitations from communication points in a multiple point operating set. Resource report processing unit 1420 is also configured to determine which upper layer resources communications device 1400 is willing to allocate for use in multiple point operation. Resource report processing unit 1420 is also configured to generate resource reports for transmission. A resource reservation processing unit 1422 is configured to process resource reservations requests. Resource reservation processing unit 1422 is also configured to determine if communications device 1400 will confirm or reject resource reservation requests. A memory 1430 is configured to store identifying information, DL data, UL data, and so on.

The elements of communications device 1400 may be implemented as specific hardware logic blocks. In an alternative, the elements of communications device 1400 may be implemented as software executing in a processor, controller, application specific integrated circuit, or so on. In yet another alternative, the elements of communications device 1400 may be implemented as a combination of software and/or hardware.

As an example, transmitter 1405 and receiver 1410 may be implemented as a specific hardware block, while resource report processing unit 1420 and resource reservation processing unit 1422 may be software modules executing in a processor 1415, a microprocessor, a custom circuit, or a custom compiled logic array of a field programmable logic array.

Although the present invention and its advantages have been described in detail, it should be understood that various changes, substitutions and alterations can be made herein without departing from the spirit and scope of the invention as defined by the appended claims.

What is claimed is:

1. A method for operating a network entity, the method comprising:
receiving a first message from a candidate communications point in a communications points set associated with a user equipment (UE), wherein the first message includes a resource report advising of an available portion of an upper layer communications resource that can be committed by the candidate communications point in a collaboration with a first communications point to communicate with the UE;
sending a second message to the candidate communications point, the second message including a resource reservation request to reserve a subset of the available portion of the upper layer communications resource; and
receiving a third message from the candidate communications point, the third message including a resource reservation response indicating whether the subset of the available portion of the upper layer communications resource has been reserved as requested.

2. The method of claim 1, further comprising confirming a commitment of the subset of the available portion of the upper layer communications resource by the candidate communications point in response to determining that the resource reservation response indicates that the subset of the available portion of the upper layer communications resource has been reserved.

3. The method of claim 1, further comprising setting the candidate communications point to be a second communications point in a second communications points set associated with the UE in response to determining that the resource reservation response indicates that the subset of the available portion of the upper layer communications resource has been reserved.

4. The method of claim 3, wherein the communications points set is a multiple point cooperating set or a multiple point measurement set, and wherein the second communications points set is a multiple point communications point set.

5. The method of claim 3, wherein the communications points set is a multiple point measurement set and the second communications points set is a multiple point cooperating set.

6. The method of claim 1, wherein receiving the first message comprises receiving a plurality of first messages from a plurality of candidate communications points of the communications points set, and wherein sending the second message comprises sending a respective second message to each candidate communications point in a subset of the plurality of candidate communications points.

7. The method of claim 1, further comprising:
sending a fourth message to the candidate communications point, the fourth message including a second resource reservation request to reserve a second subset of the available portion of the upper layer communications resource in response to determining that the resource reservation response indicates that the subset of the available portion of the upper layer communications resource has not been reserved; and
receiving a fifth message from the candidate communications point, the fifth message including a second resource reservation response indicating whether the second subset of the available portion of the upper layer communications resource has been reserved as requested by the second resource reservation request.

8. The method of claim 7, further comprising modifying the resource reservation request to produce the second resource reservation request.

9. The method of claim 7, further comprising:
sending a sixth message to the candidate communications point, the sixth message including a first resource report inquiry to request an updated resource report about a second available portion of the upper layer communications resource that can be committed by the candidate communications point in the collaboration with the first communications point to communicate with the UE; and
receiving a seventh message from the candidate communications point, the seventh message including the updated resource report.

10. The method of claim 7, wherein the third message includes an updated resource report about a third available portion of the upper layer communications resource that can be committed by the candidate communications point in the collaboration with the first communications point to communicate with the UE.

11. The method of claim 1, further comprising sending an eighth message to the candidate communications point, the eighth message including a second resource report inquiry to request the resource report about the available portion of the upper layer communications resource that can be committed by the candidate communications point in the collaboration with the first communications point to communicate with the UE.

12. The method of claim 1, wherein the resource report and the resource reservation request comprises information about the upper layer communications resource.

13. The method of claim 12, wherein the information about the upper layer communications resource includes information about a first basic communications resource element that is an indicator of availability of a set of subframes for communications with the UE.

14. The method of claim 12, wherein the information about the upper layer communications resource includes information about a second basic communications resource element that is an indicator of a multiple point communications scheme category.

15. The method of claim 14, wherein the multiple point communications scheme category includes Joint Processing, Dynamic Point Selection, Joint Transmission, Coordinated Scheduling, Coordinated Beamforming, or a combination thereof.

16. The method of claim 12, wherein the information about the upper layer communications resource includes information about a third basic communications resource element that is an indicator of a multiple point communications data splitting level option.

17. The method of claim 16, wherein the multiple point communications data splitting level option includes Medium Access Control layer, Packet Data Convergence Protocol layer, Radio Link Control layer, or a combination thereof.

18. The method of claim 12, wherein the information about the upper layer communications resource includes information about a fourth basic communications resource element that is an indicator a blend of two or more of the following: subframe availability information, multiple point communications scheme category, multiple point communications data splitting level option, available bandwidth, and committable quality of service level.

19. A method for operating a network entity, the method comprising:
receiving a first message from a first communications point, the first message including a resource reconfiguration request indicating a change in a portion of an upper layer communications resource committed by the first communications point;
determining if a second communications point accepts a commitment of a second portion of the upper layer communications resource, the second portion of the upper layer communications resource corresponding to the change in the portion of the upper layer communications resource; and
sending a second message to the first communications point, the second message including a resource reconfiguration response indicating whether the second communications point accepted the commitment of the second portion of the upper layer resource.

20. The method of claim 19, wherein determining if the second communications point accepts the commitment of the second portion of the upper layer communications resource comprises:
sending a third message to the second communications point, the third message including a resource reservation request to reserve the second portion of the upper layer communications resource; and
receiving a fourth message from the second communications point, the fourth including a resource reservation response indicating whether the second portion of the upper layer communications resource has been reserved as requested.

21. The method of claim 19, wherein determining if the second communications point accepts the commitment of the second portion of the upper layer communications resource comprises processing upper layer communications resource information.

22. The method of claim 19, further comprising determining if a third communications point accepts a commitment of a third portion of the upper layer communications resource, the third portion of the upper layer communications resource according to the change in the portion of the upper layer communications resource, in response to determining that the second communications point did not accept the commitment of the second portion of the upper layer communications resource or did not accept the commitment of the second portion of the upper layer communications resource in its entirety.

23. The method of claim 19, further comprising negotiating with the first communications point to modify the change in the portion of the upper layer communications resource in response to determining that the second communications point did not accept the commitment of the second portion of the upper layer communications resource or did not accept the commitment of the second portion of the upper layer communications resource in its entirety.

24. The method of claim 23, wherein negotiating with the first communications point comprises:
sending a fifth message to the first communications point, the fifth message including a second resource reservation request comprising the modified change in the portion of the upper layer communications resource; and
receiving a sixth message from the first communications point, the sixth message including a second resource reservation response indicating whether the first communications point accepted the modified change in the portion of the upper layer communications resource.

25. The method of claim 24, wherein the fifth message is a rejection of the resource reconfiguration request.

26. The method of claim 19, wherein the resource reconfiguration request includes information about an upper layer communications resource.

27. A communications point comprising:
a receiver configured to receive a first message from a candidate communications point in a communications points set associated with a user equipment (UE), wherein the first message includes a resource report that advises of an available portion of an upper layer communications resource that can be committed by the candidate communications point in a collaboration with a first communications point to communicate with the UE, and to receive a third message from the candidate communications point, the third message including a resource reservation response indicating whether a subset of the available portion of the upper layer communications resource has been reserved as requested; and
a transmitter configured to send a second message to the candidate communications point, the second message including a resource reservation request to reserve the subset of the available portion of the upper layer communications resource.

28. The communications point of claim 27, further comprising a processor coupled to the receiver and to the transmitter, the processor configured to confirm a commitment of the subset of the available portion of the upper layer communications resource by the candidate communications point in response to determining that the resource reservation response indicates that the subset of the available portion of the upper layer communications resource has been reserved.

29. The communications point of claim 27, wherein the transmitter is configured to send a fourth message to the candidate communications point, the fourth message including a second resource reservation request to reserve a second subset of the available portion of the upper layer communications resource in response to determining that the resource reservation response indicates that the subset of the available portion of the upper layer communications resource has not been reserved, and wherein the receiver is configured to receive a fifth message from the candidate communications point, the fifth message including a second resource reservation response indicating whether the second subset of the available portion of the upper layer communications resource has been reserved as requested.

30. The communications point of claim 27, wherein the third message includes an updated resource report about a third available portion of the upper layer communications resource that can be committed by the candidate communications point in the collaboration with the first communications point to communicate with the UE.

31. The communications point of claim 27, wherein the transmitter is configured to send a sixth message to the candidate communications point, the sixth message including a first resource report inquiry to request an updated resource report about a second available portion of the upper layer communications resource that can be committed by the candidate communications point in the collaboration with the first communications point to communicate with the UE, and wherein the receiver is configured to receive a seventh message from the candidate communications point, the seventh message including the updated resource report.

32. A communications point comprising:
a receiver configured to receive a first message from a first communications point, the first message including a resource reconfiguration request indicating a change in a portion of an upper layer communications resource committed by the first communications point;
a processor coupled to the receiver, the processor configured to determine if a second communications point accepts a commitment of a second portion of the upper layer communications resource, the second portion of the upper layer communications resource according to the change in the portion of the upper layer communications resource; and
a transmitter configured to send a second message to the first communications point, the second message including a resource reconfiguration response indicating whether the second communications point accepted the commitment of the second portion of the upper layer resource.

33. The communications point of claim 32, wherein the processor is configured to send a third message to the second communications point, the third message including a resource reservation request to reserve the second portion of the upper layer communications resource, and wherein the receiver is configured to receive a fourth message from the second communications point, the fourth including a resource reservation response indicating whether the second portion of the upper layer communications resource has been reserved as requested.

34. The communications point of claim 32, wherein the processor is configured to determine if a third communications point accepts a commitment of a third portion of the upper layer communications resource, the third portion of the upper layer communications resource according to the change in the portion of the upper layer communications resource, in response to determining that the second communications point did not accept the commitment of the second portion of the upper layer communications resource or did not accept the commitment of the second portion of the upper layer communications resource in its entirety.

35. The communications point of claim 32, wherein the processor is configured to negotiate with the first communications point to modify the change in the portion of the upper layer communications resource in response to determining that the second communications point did not accept the commitment of the second portion of the upper layer communications resource or did not accept the commitment of the second portion of the upper layer communications resource in its entirety.
